(19) United States
(12) Patent Application Publication
(10) Pub. No.: US 2024/0195626 A1
(43) Pub. Date: Jun. 13, 2024

(54) METHODS AND SYSTEMS FOR GENERATING LIMITED ACCESS NON-FUNGIBLE TOKENS

(71) Applicant: THE UNITED STATES OF AMERICA, AS REPRESENTED BY THE SECRETARY OF THE NAVY, Arlington, VA (US)

(72) Inventors: Britta Hale, Monterey, CA (US); Douglas Lee Van Bossuyt, Monterey, CA (US)

(21) Appl. No.: 18/537,426

(22) Filed: Dec. 12, 2023

Related U.S. Application Data
(60) Provisional application No. 63/431,631, filed on Dec. 9, 2022.

(51) Int. Cl. H04L 9/32; H04L 9/30

(52) U.S. Cl. CPC H04L 9/3213; H04L 9/30; H04L 9/3218; H04L 2209/603

(57) ABSTRACT

A method and system including, using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and in response to receiving a confirmation that the user has obtained ownership of the NFT, providing a private key to the user, wherein the private key is used to decrypt the NFT.

### CROSS REFERENCE TO RELATED PATENT(S) AND APPLICATION(S)

This application claims the benefit of U.S. Provisional Application No. 63/431,883, filed Dec. 12, 2022, and entitled LIMITED ACCESS NON FUNGIBLE TOKENS, which is hereby incorporated in its entirety by reference.

### BACKGROUND

This disclosure, and the exemplary embodiments described herein, describe methods and systems for generating limited access non-fungible tokens. The implementation described herein provides methods and systems for using an authenticated encryption with associated data (AEAD) process, which encrypts and authenticates a non-fungible token (NFT) and authenticates a NFT descriptor without encryption to generate a limited access non fungible tokens (LANFT), however it is to be understood that the scope of this disclosure is not limited to such application.

Non-Fungible Tokens (NFT) have received a notable amount of attention as well as investment over the past several years. These tokens are a type of “cryptoasset”, usually in the form of art but also extending to documents and files of other types or even recordings. The NFT is added to a blockchain which serves as a distributed and immutable ledger and can be sold (with recorded transaction on the blockchain) to other parties. NFT files are currently openly accessible, meaning that while NFT design proves ‘ownership’ anyone can access and use the asset without paying for the NFT, for example, by downloading a digital art file.

This disclosure, and the example embodiments described herein, provide methods and systems for Limited Access NFTs (LANFTs), where the crypto asset is only available to those who have purchased or are otherwise authorized to access the crypto asset, while also providing additional authenticated and nonencrypted NFT descriptive data which describes the digital asset and is not access limited. Namely, provided is a means for leveraging blockchain and the features of NFT, while also providing a means of exclusive access as is typical in asset curation.

### INCORPORATION BY REFERENCE

The following publications are incorporated by reference in their entirety.
[Ref. 1] Bellare, M.; Namprempre, C. (2000), T. Okamoto (ed.), “Authenticated Encryption: Relations among notions and analysis of the generic composition paradigm”, Extended Abstract in Advances in Cryptology: Asiacrypt 2000 Proceedings, Lecture Notes in Computer Science, Springer-Verlag, 1976: 531.
[Ref. 2] Oded Goldreich and Yair Oren. Definitions and Properties of Zero-Knowledge Proof Systems. Journal of Cryptology. Vol 7(1). 1-32. 1994.

### BRIEF DESCRIPTION

In accordance with one exemplary embodiment of the present disclosure, disclosed is a method for providing limited access non-fungible tokens, the method comprising: using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and in response to receiving a confirmation that the user has obtained ownership of the NFT, providing a private key to the user, wherein the private key is used to decrypt the NFT.

In accordance with another exemplary embodiment of the present disclosure, disclosed is a computer system for providing limited access non-fungible tokens, the computer system comprising: one or more processors; and one or more non-transitory computer readable media that collectively store instructions that, wherein executed by the one or more processors, cause the computing system to perform operations, the operations comprising: using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and in response to receiving a confirmation that the user has obtained ownership of the NFT, providing a private key to the user, wherein the private key is used to decrypt the NFT.

In accordance with another exemplary embodiment of the present disclosure, disclosed is one or more non-transitory computer readable media that collectively store instructions that, when executed by one or more computing devices, cause the one or more computing devices to perform operations comprising: using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and in response to receiving a confirmation that the user has obtained ownership of the NFT, providing a private key to the user, wherein the private key is used to decrypt the NFT.

### BRIEF DESCRIPTION OF THE DRAWINGS

For a more complete understanding of the present disclosure, reference is now made to the following descriptions taken in conjunction with the accompanying drawings.

FIGS. 1A and 1B show an example block chain according to an example embodiment of this disclosure.

FIGS. 2A-2C are illustrations including regular data encryption of plaintext data with a key (FIG. 2A), authenticated encryption (AE) of plaintext data using an

FIG. 3 shows an example LANFT Authenticated Encryption with Associated Data (AEAD) Process according to this disclosure.

FIG. 4 shows a block diagram of an example computing system that performs a method for providing limited access non-fungible tokens according to example embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The term “computing node”, as used herein, refers to a computational device, such as a federation of computers or servers, with an internal address that can host a copy of a blockchain and the associated transactions.

The term “configured to”, as used herein, refers to hardware, software, or a combination of hardware and software that is adapted to, set up, arranged, built, composed, constructed, designed or that has any combination of these characteristics to carry out a given function. The term “adapted to” describes the hardware, software, or a combination of hard-ware and software that is capable of, able to accommodate, to make, or that is suitable to carry out a given function.

The term “coupled,” as used herein, is defined as “connected,” although not necessarily directly and not necessarily mechanically.

The term “data object”, as used herein, refers to any data, typically in a digital format, including texts, multimedia, film, pictures, sound recordings, games, software, health data, and more.

The term “digital ledger” or “distributed ledger technology (DLT),” as used herein, refers to a digital system for recording the transaction of assets in which the transactions and their details are recorded in multiple places at the same time. Unlike traditional databases, distributed ledgers have no central data store or administration functionality. Block-chain is a type of DLT where transactions are recorded with an immutable cryptographic signature called a hash.

The term “hash function”, as used herein, refers to a mathematical algorithm that turns an arbitrarily large amount of data into a fixed-length size. The same hash will always result from the same date, but modifying the data by even one bit will completely change the hash. The values returned by the hash function are called a “hash”.

The term “non-fungible token (NFT)” or, more simply, a “token” as used herein, refers to a unit of data stored on a digital ledger, such as a blockchain, that certifies a digital asset to be unique and therefore not interchangeable. NFTs can be used to represent items such as photos, videos, audio, and other types of digital files.

The term “public data object” as used herein, refers to a description including metadata regarding a data object.

The phrase “smart contract”, as used herein, refers to a self-executing contract with terms of the contract between a buyer and a seller directly written in lines of computer code or in a transaction protocol. The smart contract is designed to automatically execute, control, or document legally relevant events and actions according to the terms of a contract.

The term “plaintext data”, as used herein, refers to an input to encryption algorithms or ciphers which transform the plaintext data into an encrypted message. It is any readable data—including binary files—in a form that can be seen or utilized without the need for a decryption key or decryption device.

It should be understood, however, that all of these and similar terms are to be associated with the appropriate physical quantities and are merely convenient labels applied to these quantities.

The NFT market valuation reached over $338 million by the end of 2020. CryptoKitties—drawings of feline caricatures—spurred the popularity of buying and selling digital art via NFTs, but now individual NFTs can reach valuation into the millions of dollars. One question following this is how to provide exclusivity of a digital asset to the market. If a person buys a physical piece of artwork, standard practice implies that they have exclusive access to it, and the ability to share with whom they choose. Even in the digital world, only those who have owned the artwork previously have a copy. However, in the maturing area of NFTs, everyone with internet access has access to and the ability to use and share the artwork—there is no method for controlling ownership and distribution in the traditional sense. As NFTs expand to use cases outside of artwork, e.g. into digital contracts, smart contracts, technological blueprints, etc., there exists a need to limit distribution of such assets while also providing a manner for a potential buyers to view description information of the digital asset, such as a blurred or partial rendering of the digital asset, for the potential buyer to determine whether or not to purchase the actual digital asset.

This disclosure, and the example embodiments described herein, provide methods and systems for Limited Access NFTs (LANFTs) which build on blockchain technology, where the crypto asset is only available to those who have purchased or are otherwise authorized to access the crypto asset, while also providing additional authenticated and nonencrypted NFT descriptive data which describes the digital asset and is not access limited. The disclosed LANFTs are generated using an AEAD (Authenticated Encryption with Associated Data Process) process which provides authentication and encryption of a plaintext data portion (NFT) and authentication only (nonencrypted) of an NFT descriptor which is associated with the Associated Data of the AEAD process.

The following is a nominal explanation of blockchain functionality, with a proof of work example based on a public blockchain technology, e.g. BITCOIN. It is to be understood that the disclosed LANFT methods and systems may apply to any type of blockchain or distributed ledger technology, including other public blockchain technology platforms, private blockchain technology platforms, hybrid blockchain technology platforms and consortium blockchain technology platforms.

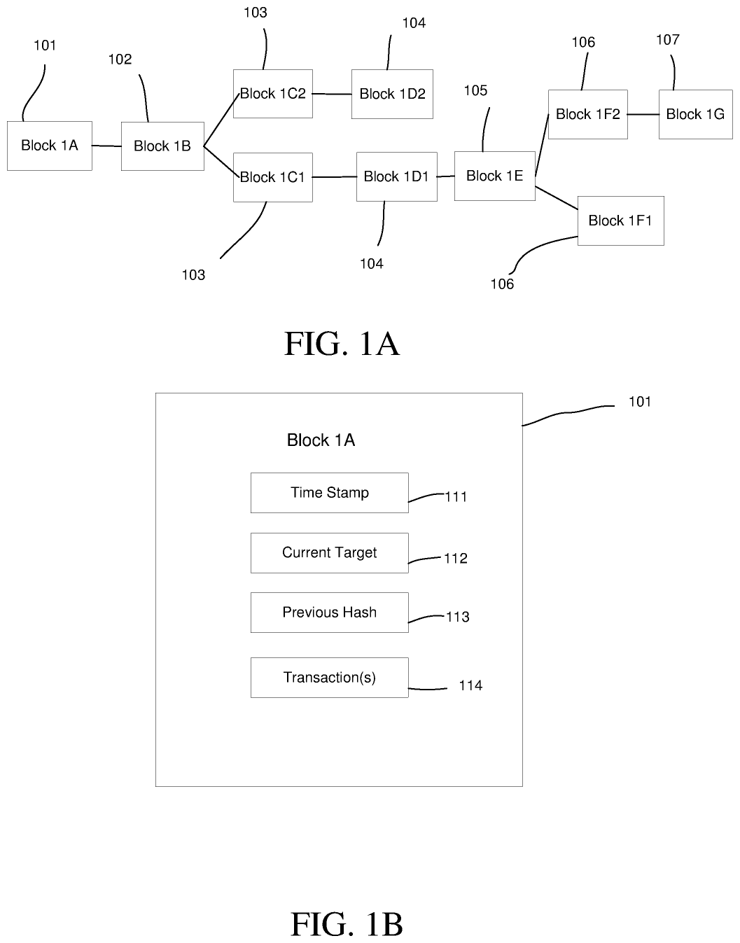

Referring to the blockchain example shown in FIG. 1A, the blockchain includes a plurality of blocks 101, 102, 103, 104, 105, 106 and 107. As shown in FIG. 1B, each of the blocks 101-107 in the chain includes multiple data fields that depend on the blockchain setting and may include a time stamp data field 111, a current target data field 112, a previous hash data field 113 and a transaction(s) data field 114 data. The data field format shown is not unique to blockchains in general and depend on the unique settings of the used blockchain and the associated block data filed format settings. However, among such block data fields, it is the transaction data field the contains the NFT which is the subject of this disclosure and example embodiments described herein.

As an aid to understand the disclosed LANFT process, provide now is a fundamental description of Authenticated Encryption with Associated Data (AEAD). See [Ref. 1].

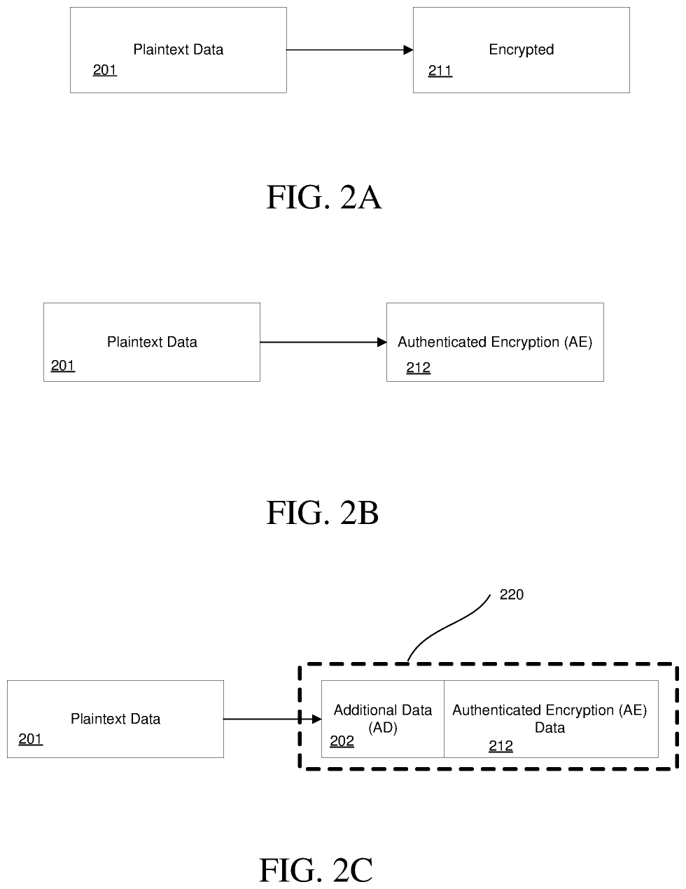

Referring to FIG. 2A, a regular data encryption process is shown where plaintext data 201 is encrypted with the use of an AEAD process. In other words, the plaintext data is encrypted, but not authenticated, using standard encryption techniques which use, for example, a private key for decryption by an authorized user. In other words, the plaintext is encrypted with some key, resulting in confidential ciphertext (i.e. such that an adversary or outsider is unable to read the plaintext).

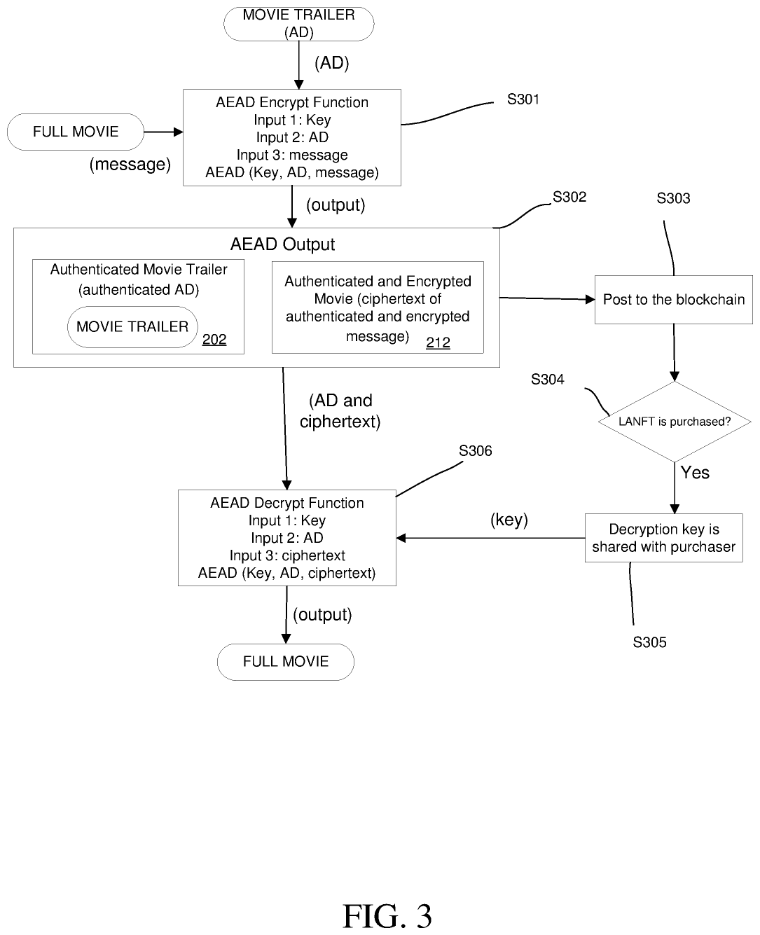

Referring to FIG. 2B, an AEAD process is shown that processes the plaintext data 201 using an Authenticated Encryption (AE) process which produces the ciphertext box 212 represents not only encrypted plaintext but authenticated ciphertext (i.e. such that an adversary or outsider is additionally unable to modify the data). (FIG. 2B) AEAD takes the above AE and adds an additional data field (AD) that is authenticated but in the clear. Namely this field is authentically linked to the AE field but is openly accessible as shown in FIG. 2C. According to this disclosure, and the example embodiments described herein, a LANFT data structure is provided as shown in FIG. 2C and as will be further described with reference to FIG. 3 below.

In other words, the use of an AEAD is a process is used for limiting access to the NFT. The NFT is encrypted into the AE field, with a “reduced NFT version” presented in the AD field. Authentication may take place as a singular AEAD algorithm, or through use of digital signatures. An optional Non-Interactive Zero Knowledge proof may be used to prove to anyone in possession of the AD field that the NFT owner does in fact possess a full NFT in encrypted form. When the NFT is sold, the new owner receives a copy of the private key.

The “reduced NFT” in the AD field may be a pixelized or blurred form of the NFT (e.g. for art), art title, diagram name, partial image, or other representation. For example, the NFT may contain a movie file, while the “reduced NFT” in the AD field contains the movie trailer. In a parallel analogy, an NFT may contain restricted documents, while the “reduced NFT” contains unrestricted description and front-page information. The reduced form serves as a marketing description, but only end buyers obtain full access to the NFT.

In addition, cryptographic Non-Interactive Zero Knowledge Proofs (NIZK), see [Ref. 2], of various types may be added to the AD field to prove to the buyer that the full NFT is actually within the encrypted data.

FIG. 3 shows an example NFT Authenticated Encryption with Associated Data (AEAD) Process according to this disclosure. The example illustrated includes a NFT including a movie and an NFT descriptor including a movie trailer which only includes a preview of the NFT movie.

At step S301, an AEAD Encrypt Function process receives a Movie Trailer file (AD) at Input 2, and the Full Movie file (NFT/message) at Input 3 and Key at Input 1: AEAD (Key, AD, message). Step 301 AEAD process authenticates both the full NFT Movie file and Movie file descriptor, and encrypts only the full NFT Movie file as previously discussed herein. As shown in S302, the output of the AEAD process S301 includes an LANFT blockchain block including a first portion including the Authenticated and Encrypted Movie (ciphertext of authenticated and encrypted message) 212 and the Authenticated Movie Trailer (authenticated AD) 202.

At step S303, the LANFT blockchain block is posted to the blockchain or similar distributed ledger for distribution to potential buyers and/or other authorized users.

At step S304, the LANFT generation and distribution process remains in an idle state until a buyer or other authorized user either purchases the LANFT or acquires the necessary authorization to access the full Movie file NFT, at which point the process shares a decryption key with the authorized buyer/user at S305.

At step S306, an AEAD Decryption Function process is performed, including Input 1: Key, Input 2: AD Input and 3: ciphertext AEAD (Key, AD, ciphertext). The AEAD Decryption Function decrypts the NFT full Movie file which is then available for viewing by the authorized buyer/user.

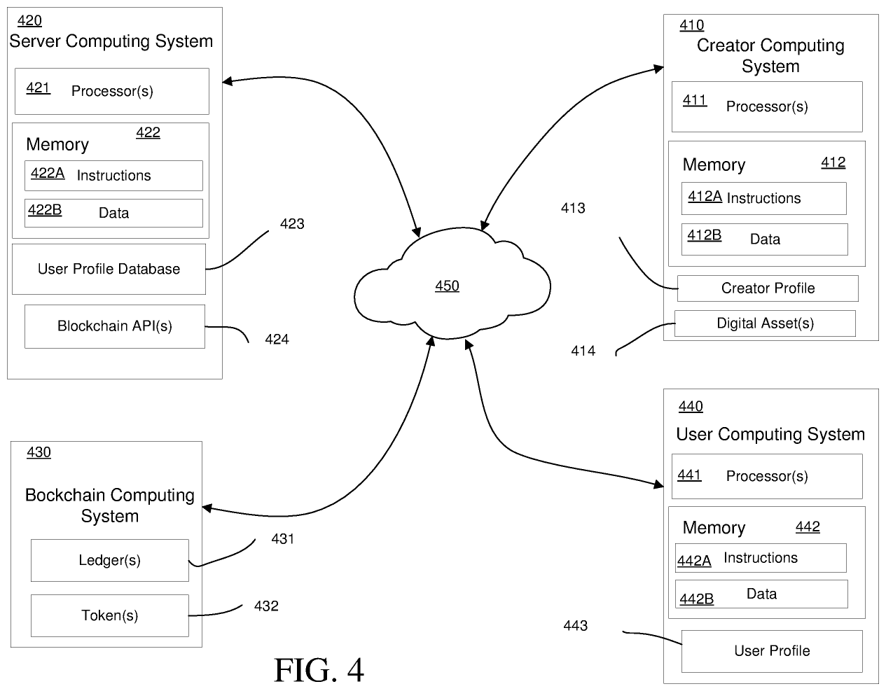

FIG. 4 shows a block diagram of an example computing system that performs a method for providing limited access non-fungible tokens according to example embodiments of the present disclosure.

As shown in FIG. 4, the system includes a user computing system 440, a server computing system 420, a creator computing system 410, and a blockchain computing system 430 that are communicatively coupled over a network 450. The user computing system 440 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 440 includes one or more processors 441 and a memory 442. The one or more processors 441 can be any suitable processing device (e.g., a processor core, a microprocessor, an ASIC, a FPGA, a controller, a microcontroller, etc.) and can be one processor or a plurality of processors that are operatively connected. Memory 442 can include one or more nontransitory computer readable storage mediums, such as RAM, ROM, EEPROM, EPROM, flash memory devices, magnetic disks, etc., and combinations thereof. Memory 442 is configured to store data 442B and instructions 442A which are executed by the processor 432 to cause the user computing system 440 to perform operations.

The user computing system 440 can also include one or more user input components that receive user input. For example, the user input component can be a touch sensitive component (e.g., a touch-sensitive display screen or a touch pad) that is sensitive to the touch of a user input object (e.g., a finger or a stylus). The touch-sensitive com-ponent can serve to implement a virtual keyboard. Other example user input components include a microphone, a traditional keyboard, or other means by which a user can provide user input.

The server computing system 420 includes one or more processors 421 and a memory 422. The one or more processors 421 can be any suitable processing device (e.g., a processor core, a microprocessor, an ASIC, a FPGA, a controller, a microcontroller, etc. which can reside on a physical server or be cloud-based.) and can be one processor or a plurality of processors that are operatively connected. Memory 422 can include one or more nontransitory computer readable storage mediums, such as RAM, ROM, EEPROM, EPROM, flash memory devices, magnetic disks, etc., and combinations thereof. The memory 422 is configured to store data 422B and instructions 422A which are executed by the processor 421 to cause the server computing system 420 to perform operations.

In some implementations, the server computing system 420 includes or is otherwise implemented by one or more server computing devices. In instances in which the server computing system 420 includes plural server com-puting devices, such server computing devices can operate according to sequential computing architectures, parallel computing architectures, or some combination thereof.

The blockchain computing system 430 includes one or more processors and a memory. The one or more processors can be any suitable processing device (e.g., a processor core, a microprocessor, an ASIC, a FPGA, a controller, a microcontroller, etc.) and can be one processor or a plurality of processors that are operatively connected. The memory can include one or more nontransitory computer readable storage mediums, such as RAM, ROM, EEPROM, EPROM, flash memory devices, magnetic disks, etc., and combinations thereof. The memory can store data and instructions which are executed by the processor to cause the blockchain computing system 430 to perform operations. In some implementations, the blockchain computing system 430 includes or is otherwise implemented by one or more server computing devices.

The network 450 can be any type of communications network, such as a local area network (e.g., intranet), wide area network (e.g., Internet), or some combination thereof and can include any number of wired or wireless links. In general, communication over the network 450 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Instructions 422A can be executed by the processor(s) 421 to implement the LANFT generation and distribution process as described herein. The user profile database 420 can be configured to store a plurality of user profiles associated with a plurality of users utilizing one or more user computing systems 440. In some implementations, the user profile database 423 can be configured to be utilized for facilitating one or more interactions. The facilitation of the one or more interactions can involve the use of a blockchain application programming interface (API) 424 to send data to and receive data from a blockchain computing system 430. For example, a server computing system 420 can utilize the blockchain API 424 to update one or more ledgers 431 of the blockchain computing system 430. The one or more ledgers 431 can be associated with one or more tokens 432. The one or more tokens 432 can include one or more non-fungible tokens, which can include scripts associated with a digital asset (e.g., image data, video data, text data, latent encoding data, domain data, audio data, augmented reality asset rendering data, and/or virtual reality asset rendering data). In particular, the script can reference a specific digital asset that is provided for sale. The digital asset can include one or more of an image data, text data, video data, latent encoding data, a domain name, a virtual property, an augmented reality asset, a virtual reality asset (e.g., a virtual reality environment and/or a virtual reality object for interaction in an environment), a smart contract, a physical item authentication, etc.

Instructions 442A can provide instructions for implementing a browser, a non-fungible token purchase, and/or a plurality of other functions. In particular, the user of user computing system 440 can exchange data with server 420 by using the browser to visit a website accessible at a particular web address. The LANFT as described herein can be provided as an element of a user interface of a website and/or application.

The user computing system 440 can also include a user profile 443 that can be used to identify a user of the user computing system 440. The user profile 443 can be optionally used by the user to make one or more transactions which can then be recorded on one or more ledgers 431 of the blockchain computing system 430. The user profile 443 can be descriptive of user information, which can include identification numbers, public keys, and/or payment account information. For example, the user profile 443 can include data associated with a crypto wallet, which may be linked to a browser application via an application extension and/or embedding.

The network 450 can be any type of communications network, such as a local area network (e.g., intranet), wide area network (e.g., Internet), or some combination thereof. The network 450 can also include a direct connection between a client device 440 and the server 420. In general, communication between the server 420 and a client device 440 can be carried via network interface using any type of wired and/or wireless connection, using a variety of communication protocols (e.g., TCP/IP, HTTP), encodings or formats (e.g., HTML, XML), and/or protection schemes (e.g., VPN, secure HTTP, SSL).

In some implementations, the exemplary computing system can include one or more creator computing systems 410. The one or more creator computing systems 410 can be utilized for generating images, videos, prose, poetry, audio, etc., which can then be provided for sale. The one or more creator computing systems 410 can include one or more processors 411, which can be utilized to execute one or more operations to implement the systems and methods disclosed herein. The one or more creator computing systems 410 can include one or more memory components 412, which can be utilized to store data 412B and one or more instructions 412A. Data 412B can include data related to one or more applications, one or more media datasets, etc. Instructions 412A can include one or more operations for implementing the systems and methods disclosed herein.

The one or more creator computing systems 410 can store data associated with one or more digital assets 414 and/or one or more creator profiles 413. The one or more digital assets 414 can include text data, image data, video data, audio data, latent encoding data, domain data, or a variety of other data formats. The one or more creator profiles 413 can include information associated with one or more “creators” of the one or more digital assets 414. The one or more creator profiles 413 can include identification data, transaction data, and/or crypto wallet data.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD ROMs, and magnetic optical disks, read only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine readable medium includes any mechanism for storing or transmitting information in a form readable by a machine (e.g., a computer). For instance, a machine readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a nontransitory computer readable recording medium on which a control program is recorded, such as a disk, hard drive, or the like. Common forms of nontransitory computer readable media include, for example, floppy disks, flexible disks, hard disks, magnetic tape, or any other magnetic storage medium, CD ROM, DVD, or any other optical medium, a RAM, a PROM, an EPROM, a FLASH EPROM, or other memory chip or cartridge, or any other tangible medium from which a computer can read and use.

It will be appreciated that variants of the above disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method for providing limited access non-fungible tokens, the method comprising:
using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and
in response to receiving a confirmation that the user has obtained ownership of the NFT, providing a private key to the user, wherein the private key is used to decrypt the NFT.

2. The method of claim 1, wherein the NFT descriptor further comprises a non-interactive zero knowledge proof that is used to confirm the ownership or possession of the NFT.

3. The method of claim 1, wherein the NFT descriptor includes one or more of a pixelated NFT version, a watermarked NFT version, and a descriptive NFT version.

4. The method of claim 1, wherein the NFT is only viewable by past owners of the NFT.

5. The method of claim 1, wherein the NFT is one of group consisting of a digital picture, movie, sound recording, game, software, and health data

6. The method of claim 1, wherein the AEAD process includes a Message input, an Associated Data (AD) input and an AEAD output, the AEAD process configured to authenticate and encrypt the Message input, authenticate the AD message without encryption, and the AEAD output is a blockchain block data string including the authenticated and encrypted Message, wherein the Message input is associated with the NFT and the AD input is associated with the NFT descriptor.

7. The method of claim 1, further comprising:
after generating the LANFT including an authenticated and encrypted NFT portion and an authenticated and nonencrypted NFT descriptor portion, posting the LANFT to a blockchain.

8. A computer system for providing limited access non-fungible tokens, the computer system comprising:
one or more processors; and
one or more non-transitory computer readable media that collectively store instructions that, wherein executed by the one or more processors, cause the computing system to perform operations, the operations comprising:
using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and
in response to receiving a confirmation that the user has obtained ownership of the NFT, providing a private key to the user, wherein the private key is used to decrypt the NFT.

9. The computer system according to claim 8, wherein the NFT descriptor further comprises a non-interactive zero knowledge proof that is used to confirm the ownership or possession of the NFT.

10. The computer system according to claim 8, wherein the NFT descriptor includes one or more of a pixelated NFT version, a watermarked NFT version, and a descriptive NFT version.

11. The computer system according to claim 8, wherein the NFT is only viewable by past owners of the NFT.

12. The computer system according to claim 8, wherein the NFT is one of group consisting of a digital picture, movie, sound recording, game, software, and health data.

13. The computer system according to claim 8, wherein the AEAD process includes a Message input, an Associated Data (AD) input and an AEAD output, the AEAD process configured to authenticate and encrypt the Message input, authenticate the AD message without encryption, and the AEAD output is a blockchain block data string including the authenticated and encrypted Message, wherein the Message input is associated with the NFT and the AD input is associated with the NFT descriptor.

14. The computer system according to claim 8, after generating the LANFT including an authenticated and encrypted NFT portion and an authenticated and nonencrypted NFT descriptor portion, posting the LANFT to a blockchain.

15. One or more non-transitory computer readable media that collectively store instructions that, when executed by one or more computing devices, cause the one or more computing devices to perform operations comprising:
using an authenticated encryption with associated data (AEAD) process, encrypting and authenticating a non-fungible token (NFT) and authenticating a NFT descriptor without encryption to generate a limited access non fungible tokens (LANFT), the LANFT including an authenticated and encrypted NFT portion and an authenticated and nonencrypted NFT descriptor portion which is viewable by a user prior to obtaining ownership of the NFT; and
in response to receiving a confirmation that the user has obtained ownership of the NFT, providing a private key to the user, wherein the private key is used to decrypt the NFT.

16. The one or more non-transitory computer readable media according to claim 15, wherein the NFT descriptor further comprises a non-interactive zero knowledge proof that is used to confirm the ownership or possession of the NFT.

17. The one or more non-transitory computer readable media according to claim 15, wherein the NFT descriptor includes one or more of a pixelated NFT version, a watermarked NFT version, and a descriptive NFT version.

18. The one or more non-transitory computer readable media according to claim 15, wherein the NFT is one of group consisting of a digital picture, movie, sound recording, game, software, and health data.

19. The one or more non-transitory computer readable media according to claim 15, wherein the AEAD process includes a Message input, an Associated Data (AD) input and an AEAD output, the AEAD process configured to authenticate and encrypt the Message input, authenticate the AD message without encryption, and the AEAD output is a blockchain block data string including the authenticated and encrypted Message, wherein the Message input is associated with the NFT and the AD input is associated with the NFT descriptor.

20. The one or more non-transitory computer readable media according to claim 15, wherein after generating the LANFT including an authenticated and encrypted NFT portion and an authenticated and nonencrypted NFT descriptor portion, posting the LANFT to a blockchain.
